(19) United States
(12) Patent Application Publication
(10) Pub. No.: US 2019/0215677 A1
(43) Pub. Date: Jul. 11, 2019

(54) Methods for Identifying an Electronic Component

(71) Applicant: Robert Bosch GmbH, Stuttgart (DE)

(72) Inventors: Adrien Mouaffo Tiadjio, Neu-Ulm (DE); Christoph Maier, Kleinostheim (DE); Jochen Mueller, Backnang (DE); Patric Brand, Sennfeld (DE); Peter Rehbein, Erlabrunn (DE); Roman Ritter, Stuttgart (DE); Sebastian Vornwald, Wuerzburg (DE); Stephan Wiesmann, Gemuenden (DE); Thomas Inderwies, Frammersbach (DE); Wolfgang Rueppel, Frammersbach (DE)

(21) Appl. No.: 16/241,472

(22) Filed: Jan. 7, 2019

(30) Foreign Application Priority Data
Jan. 8, 2018 (DE) 10 2018 200 132.4

(51) Int. Cl. H04W 8/00; H04W 88/06

(52) U.S. Cl. CPC H04W 8/005; H04W 88/06

(57) ABSTRACT

A method for identifying an electronic component includes receiving an activity signal output by the electronic component when a light intensity incident on the electronic component exceeds a predeterminable threshold. The activity signal is assignable to the electronic component. The method further includes outputting the identification of the electronic component based on the received activity signal.

This application claims priority under 35 U.S.C. § 119 to patent application no. DE 10 2018 200 132.4, filed on Jan. 8, 2018 in Germany, the disclosure of which is incorporated herein by reference in its entirety.

The disclosure relates to two methods for identifying an electronic component.

### BACKGROUND

It is known to connect electronic components to the server via a radio connection, for example. In this case, an individual ID can be allocated to each electronic component that is connected to a server. Consequently, with the server it is possible to distinguish between the individual electronic components. However, it is often difficult to recognize on the electronic component itself what ID is allocated to this component at a digital level. By way of example, the ID may be provided on a sticker on the electronic component. However, this also necessitates identifying the electronic component at least once and ascertaining the ID. Even identifying the electronic components once in this way may be complex. Furthermore, it is not possible to ensure that an ID indicated on a sticker is still up to date. Consequently, relying on such indications may be a practice that is susceptible to errors.

### SUMMARY

Taking this as a departure point, it is an object of the disclosure here to solve or at least reduce the technical problems outlined in association with the prior art. The intention is, in particular, to present methods for identifying an electronic component by means of which the electronic component can be identified with particularly low complexity and/or particularly reliably.

This object is achieved by means of a method for identifying an electronic component and a method for configuring a plurality of electronic components and a database for identifying the electronic components in accordance with the features of the independent patent claims. Further advantageous embodiments of the methods are specified in the respectively dependent patent claims. The features presented individually in the patent claims are combinable with one another in any desired, technologically expedient manner and can be supplemented by explanatory substantive matter from the description, wherein further embodiment variants of the disclosure are demonstrated.

A method for identifying an electronic component is presented which comprises at least the following method steps:

a) receiving an activity signal output by the electronic component if a light intensity incident on the electronic component exceeds a predeterminable threshold, wherein the activity signal is assignable to the electronic component,
b) outputting the identification of the electronic component on the basis of the activity signal received in accordance with step a).

The electronic component preferably comprises a communication module with which the electronic component can communicate with a data network, and in particular with a receiver of the data network. By way of example, the communication can take place via Bluetooth®, WLAN and/or a radio connection. Preferably, the electronic component is of autonomous design such that the electronic component can be operated without a cable connection. For this purpose, the electronic component preferably has a battery, in particular.

The method described is directed, in particular, to identifying the electronic component. In this case, the electronic component can be, in particular, one of a plurality of electronic components which are linked to the data network. In this case, an individual identification, for example a unique identification number, can be allocated in particular to each of the electronic components. In that case, identifying the electronic component is ascertaining the identification, in particular the identification number of the electronic component. In the case of a plurality of electronic components, identifying one of the electronic components means that a user of the method firstly selects one of the electronic components and that the user obtains the identification of this selected electronic component by means of the method described. The user can thus obtain in particular an assignment between an electronic component physically available to said user and a digitally present identification assigned to said electronic component. As an alternative or in addition to a digitally present identification number, the identification can also be present as a digitally present designation of the respective electronic component. In this regard, identifying the electronic component can consist in displaying to a user a name of the selected electronic component, said name being present at the digital level.

The user can select the electronic component by ensuring that a light intensity incident on the electronic component is particularly high or exceeds a predefinable minimum intensity threshold value. For this purpose, the user can aim at the electronic component for example using a flashlamp or a laser pointer or some other apparatus that emits a concentrated or focused light beam. Even if the electronic component is provided for example at a poorly accessible location of an installation, the user can thus select or reach the electronic component particularly easily.

The light intensity can be measured by means of a light sensor on or in the electronic component. If the measured light intensity exceeds the predeterminable threshold, the electronic component preferably emits an activity signal. The activity signal is received in accordance with step a). The activity signal is preferably received by the data network and/or the mobile terminal. By receiving the activity signal, the data network and/or the mobile terminal acquire(s) knowledge of the fact that the light intensity of a specific electronic component has exceeded the predeterminable threshold. It is preferably assumed in that case that the user has illuminated the corresponding electronic component. The predeterminable threshold is therefore preferably dimensioned such that the situation in which the light intensity was exceeded on account of some other event can be ruled out with high probability. In this regard, the predeterminable threshold is preferably at least sufficiently different or greater than a light intensity prevailing in daylight.

The activity signal is assignable to the electronic component which emitted it. Accordingly, step b) of the method described can involve outputting the identification of the electronic component from which the activity signal was received. The identification can be output in particular by being displayed on a display of a mobile terminal, wherein the mobile terminal is preferably connected to the data network. In this case, by way of example, an identification number can be displayed. However, it is also possible to highlight the corresponding entry in a list of all identification numbers which corresponds to the selected electronic component.

The situation in which the activity signal is assignable to the electronic component can be realized in various ways. By way of example, the activity signal can be received in particular in such a way that an assignment of the received activity signal to the electronic component is possible by way of the reception channel. In this regard, a respective channel via which the corresponding activity signal can be received can be provided for example for each electronic component. If an activity signal is received on a specific channel, it is preferably assumed that the electronic component assigned to this channel has been illuminated and thus selected by the user.

Alternatively or additionally, the activity signal can be designed individually for each electronic component.

In that case, in particular, an embodiment of the method is preferred in which step b) involves accessing a database in which, for a plurality of electronic components, a respective identification is stored as assigned to the corresponding electronic component, and wherein step b) involves outputting the identification stored in the database as assigned to the electronic component from which the activity signal was received in accordance with step a).

In the database, a respective assignment between at least one property of the activity signal and the identification of the electronic component can be stored in particular for each electronic component. By way of example, if each of the electronic components emits an activity signal having unique coding, frequency, voltage or voltage amplitude and/or pulse duration, the identification assigned to the electronic component can be ascertained by accessing the database.

In the database, a respective identification can be assigned to a number or each reception channel. In that case, an assignment of the reception channel to the electronic component can be obtained via the database.

In one embodiment of the method, the activity signal comprises the identification of the electronic component. The activity signal can already comprise the identification to be output, such that the latter can be forwarded in step b). In this case, what can be expressed by “forward” is that the identification is received in a first data format and output in a second data format.

In one embodiment of the method, the predeterminable threshold is time-dependent in such a way that the activity signal is output by the electronic component if a light signal having a predefinable light intensity sequence is received by the electronic component. The electronic components may also be exposed to light intensities that fluctuate into the environment. In production installations, in particular, variations in the light intensity may occur for a wide variety of reasons. This entails the risk of an electronic component erroneously outputting an activity signal. This risk can hereby be considerably reduced. For example, a light intensity is taken into account only if it is present as a predefined light intensity sequence. In this regard, a temporal sequence of light pulses (of identical type or different) can be emitted for example by means of a correspondingly configured flashlamp. It is only if this specific sequence is received by the light sensor of the electronic component that the electronic component emits the activity signal. The probability that a light intensity sequence that is predefined in this way will occur randomly can be assumed to be very low.

In one embodiment of the method, the activity signal is output by the electronic component only if the light intensity of at least one predefinable wavelength and/or in at least one predefinable wavelength range exceeds a respective predeterminable threshold. In this embodiment, too, the probability of erroneous triggering can be considerably reduced. For this purpose, it is possible to use for example a laser pointer that emits (only) light of a specific wavelength and/or in a narrowly delimited wavelength range. The probability that an increase in the light intensity will occur randomly in precisely this wavelength range is lower than when considering all wavelengths that are measurable by the light sensor. That holds true in particular in the preferred case where the activity signal is outputted by the electronic component only if the light intensity of the at least one predefinable wavelength and/or in the at least one predefinable wavelength range exceeds the respective predeterminable threshold and at the same time the other wavelengths do not exceed respectively predeterminable thresholds. An amplification of the light intensity of one specific wavelength and/or in one specific wavelength range vis-à-vis the other wavelengths is thus demanded.

As a further aspect, a method for configuring a plurality of electronic components and a data network for identifying the electronic components is presented, comprising at least the following method steps which are carried out once in each case for each of the electronic components:

A) providing the electronic component at a preparation position that is assignable to the electronic component,
B) illuminating the electronic component provided in accordance with step A) with a light beam in the preparation position,
C) receiving an activity signal output by the electronic component illuminated in accordance with step B),
D) storing an identification of the electronic component in a database of the data network as assigned to the preparation position of the electronic component.

The particular advantages and embodiment features described for the method for identifying an electronic component are applicable and transferable to the method for configuring a plurality of electronic components and a database for identifying the electronic components, and vice versa.

The electronic components are provided in respective step A). All steps A) can be carried out (at least in part) simultaneously. In this regard, all the electronic components can be arranged for example in a grid or in a line. Each electronic component is thus determined unambiguously by way of its preparation position.

Step B) involves illuminating the electronic component. That is preferably carried out by all the electronic components being illuminated individually in each case one after another. If an electronic component is illuminated, it emits a respective activity signal, which is received in respective step C). In respective step D), it is subsequently possible to add an entry to the database, in which entry preparation position and identification of the electronic component are assigned to one another.

By means of the method described, by way of example, the electronic component in column 2 and row 5 of a grid in which the electronic components are arranged can be assigned to the corresponding identification number. The indication “column 2, row 5” is comprehensible to the user, whereas the user cannot straightforwardly discern the identification number of an electronic component from the latter.

In one embodiment, the method furthermore comprises the following method steps which are carried out in each case once for each of the electronic components:

E) positioning the electronic component at a respective operation position, and
F) assigning the identification of the electronic component in the database to the operation position of the electronic component and/or at least one property that is assignable to the operation position.

In the present embodiment, the method described can be used to fit the electronic components for example on an installation. In this case, an operation position is preferably allocated to each electronic component. In this regard, by way of example, a first electronic component can be provided on a motor of the installation in order to measure a first temperature there. A second one of the electronic components can be provided for example on an electronic unit of the installation in order to measure a second temperature there. Step E) involves positioning the electronic components at the respective operation position. That can be carried out in particular by the electronic component being adhesively attached.

In step F), the entry of each electronic component can be extended by an operation position and/or by at least one property that is assignable to the operation position. In this case, the operation position can be indicated in particular directly by way of a naming of the operation position (e.g. “first operation position”) or by way of one or more properties of the operation position (“on the motor”).

By way of example, the fact that the electronic component from the preparation position “column 2, row 5” was positioned in the operation position “on the motor” can be entered into the database. Besides these indications, the database entry of this electronic component preferably also comprises the identification of the electronic component.

When carrying out the method for identifying the electronic component, the user, by illuminating an electronic component, can preferably receive as output the identification and in addition also the operation position and/or the at least one property that is assignable to the operation position.

In a further embodiment of the method, the illuminating in step B) is carried out by an illumination unit by virtue of the fact that a light beam output by the illumination unit is guided onto the respective preparation position, and wherein a position signal with the respective illuminated preparation position is output, on the basis of which position signal the identification is assigned to the corresponding preparation position in step D). In this embodiment, illuminating in step B) is carried out in an automated manner such that the electronic components are illuminated one after another and the respective activity signal are output correspondingly one after another. The position signal is preferably output by the illumination unit and received by a process control unit that is intended and configured for carrying out the present method. In that case, the position signal preferably comprises a passive indication by the illumination unit of which preparation position is illuminated at a specific point in time. In this regard, the indication of which preparation position is illuminated at a specific point in time can be assigned to an activity signal received at said point in time and thus to a specific electronic component. Alternatively, the position signal can be output by the process control unit and be received by the illumination unit. In that case, the position signal preferably comprises an active request to the illumination unit to illuminate a specific preparation position.

The illumination unit preferably comprises at least one light source that can emit the light beam into the individual preparation position. The light source preferably has an optical unit that is variable in such a way that the light beam can be adjusted between the preparation positions in an automated manner, such that in particular exactly one preparation position is illuminated at a specific point in time.

In a further embodiment of the method, the illuminating in step B) is carried out by a screen by virtue of the fact that a region of the screen that is assignable to the respective preparation position is activated, and wherein a position signal with the respective illuminated preparation position is output, on the basis of which position signal the identification is assigned to the corresponding preparation position in step D). Instead of the illumination unit with an adjustable light beam in accordance with the embodiment discussed previously, a screen is provided in the present case. By activating regions of the screen with which only one preparation position in each case is illuminated, it is likewise possible for all the electronic components to be illuminated one after another. The position signal is preferably output by the screen to the process control unit as a passive notification of which preparation position is illuminated at a specific point in time. Alternatively, the process control unit can output the position signal as an active request to the screen, whereby that region of the screen which is to be illuminated at a specific point in time is predefined for the screen.

As further aspects, a computer network, a process control unit, a computer program and an electronic component are presented, each of which is intended and configured for carrying out one of the methods described. Furthermore, a machine-readable storage medium on which the computer program described is stored is presented. Also presented is an illumination unit that is intended and configured for carrying out the method described in the embodiment in which illuminating in step B) is carried out by an illumination unit.

The advantages and embodiment features described for the two methods are applicable and transferable to the data network, the process control unit, the computer program, the machine-readable storage medium, the electronic component and the illumination unit.

The disclosure and the technical milieu are explained in greater detail below with reference to the figures. The figures show one exemplary embodiment, although the disclosure is not restricted thereto. For clarification it should be pointed out that the technical features illustrated in the figures can also be combined with features of other figures and/or the description, without other technical features of a figure needing to be adopted. If there is a technical necessity to combine manifestations of one technical feature with those of another, reference is made or attention is drawn explicitly to this, such that otherwise there is a free combinability of these features.

### BRIEF DESCRIPTION OF THE DRAWINGS

In the figures, schematically:

FIG. 1: shows two electronic components with a light source, a computer network and a mobile terminal,

FIG. 2: shows an installation with a plurality of electronic components and also a light source, a computer network and a data network,

FIG. 3: shows an arrangement for preparing the electronic components from FIG. 2,

FIG. 4: shows a method for identifying an electronic component as disclosed herein, and

FIG. 5: shows a method for configuring a plurality of electronic components and a data network for identifying the electronic components as disclosed herein.

### DETAILED DESCRIPTION

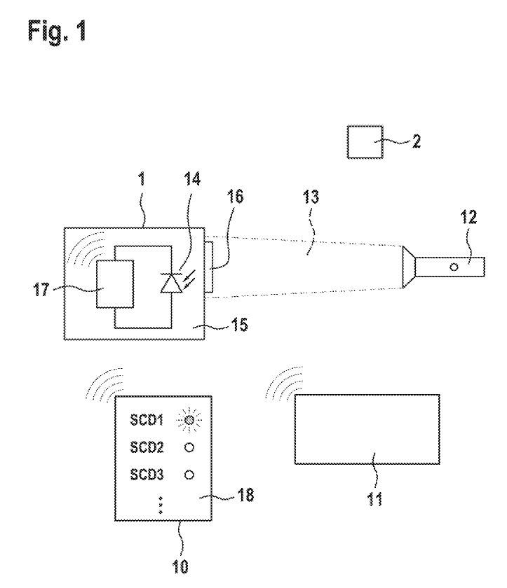

FIG. 1 shows a first electronic component 1 and a second electronic component 2, which is merely indicated. The electronic components 1 and 2 are logged onto a computer network 11 in each case by Bluetooth® and transmit sensor data to a server or to a mobile terminal 10 via a gateway of the computer network 11.

The electronic component 1 has a microcontroller 17 with a Bluetooth® radio interface. A light sensor 14 such as a photodiode, for example, is connected to an analogue measurement input of the microcontroller 17. A transparent region 16 is provided in a housing 15 of the electronic component 1, said transparent region enabling the light sensor 14 to be illuminated from outside. The second electronic component 2 can be designed like the first electronic component 1, no details for the second electronic component 2 being shown in FIG. 1.

A light source 12 having a narrowly focused light beam 13 is directed onto the electrical component 1. The light source 12 can be a flashlamp (preferably an LED lamp) having an optical lens that concentrates the light beam 13 or causes it to emerge with a defined luminous cone that is as narrow as possible. A parallel, non-expanding light beam 13 comprising a circle of light of 1 cm, for example, is preferred. It is also possible to use a laser light source, for example a laser pointer. In this case, the light beam 13 can be expanded to 1 cm, for example.

The electronic components 1 and 2 logged onto the computer network 11 are displayed on a display 18 of the mobile terminal 10, e.g. as a list with an unambiguous identifier of the electronic component 1, 2 (for example as uuID). An indicator of a light sensor channel of an electronic component 1, 2 is displayed in each case after an entry of an electronic component 1, 2 in the list. The list of electronic components 1, 2 and the indicator (e.g. a button symbol or a symbol of an indicator lamp) are displayed e.g. by an app in which the necessary functions are realized using software and which is executed on the mobile terminal 10.

If the light intensity at the light sensor 14 of an electronic component 1, 2 exceeds a predeterminable threshold, then the indicator is activated (for example by lighting up, by a change of color and/or by flashing). The mobile terminal 10 can retrieve the necessary data (uuID, associated value of the sensor channel) from a server to which the electronic components 1, 2 communicate the data by Bluetooth® via the computer network 11. In this respect, the mobile terminal 10 can be regarded as a display and input device for the computer network 11. However, the mobile terminal 10 can also itself be a destination of the data communicated by the electronic components 1, 2 and in this respect be regarded as part of the computer network 11.

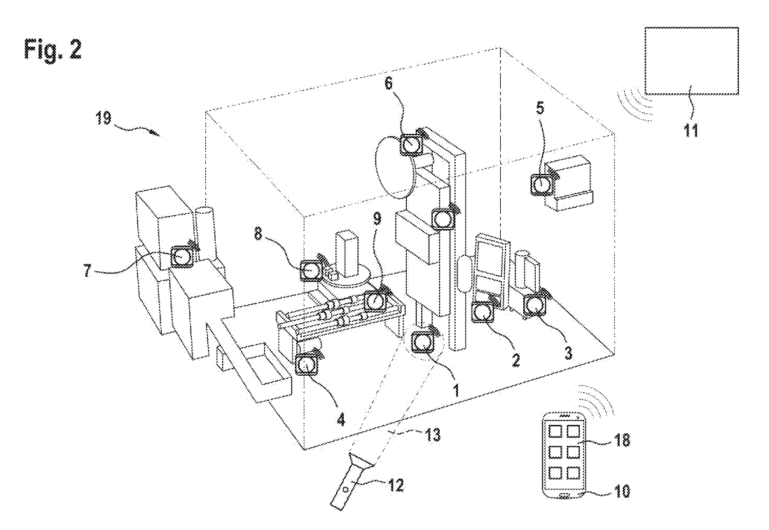

FIG. 2 shows one exemplary application of the method described. Nine electronic components 1 to 9 are installed on an installation 19 such as a machine tool, for example. A computer network 11 provides a Bluetooth® network, with the electronic components 1 to 9 being logged onto the latter. Via the computer network 11, the electronic components 1 to 9 communicate measurement data to a server (not shown). Let it be assumed that an engineer has the task of exchanging a specific one of the electronic components 1 to 9. That may be the case, for example, because a battery of the electronic component is dead. It may also be assumed that the engineer would like to service a specific component on which the electronic component is fitted.

The engineer may receive, displayed on the mobile terminal 2, the electronic components 1 to 9 of the installation 19 and information as to on which of the electronic components 1 to 9 or on which component of the installation 19 that is assigned to one of the electronic components 1 to 9 work is to be carried out. On the display 18 of the mobile terminal 2, by way of example, a list containing the electronic components 1 to 9 may be displayed, optionally with the respective component of the installation 19 to which the electronic component is assigned. Furthermore, the list may comprise an indicator for a respective light sensor channel of the electronic components 1 to 9.

In this regard, the following may be displayed on the display 18, for example:

| Electronic | | |
|---|---|---|
| component | Component of the installation 19 | Indicator |
| 1 | Exterior unit | (◯) |
| 2 | Pump unit | (◯) |
| 3 | Valve 1 magnet right | (◯) |
| 4 | Valve 1 magnet left | (◯) |
| 5 | Rail guide 1 | (◯) |
| . . . | | |

If the engineer uses the light source 12 to illuminate the electronic components 1 to 9 in question one after another, said engineer recognizes from the respective indicator on the display 18 of the mobile terminal 10 whether he/she has struck the correct one of the electronic components 1 to 9 with the light beam 13. In this way, said engineer can unambiguously identify a desired one of the electronic components 1 to 9 or a desired component of the installation 19. The following may be displayed on the display 18 of the mobile terminal 10, for example:

| Electronic | | |
|---|---|---|
| component | Component of the installation 19 | Indicator |
| 1 | Exterior unit | (X) |
| 2 | Pump unit | (◯) |
| 3 | Valve 1 magnet right | (◯) |
| 4 | Valve 1 magnet left | (◯) |
| 5 | Rail guide 1 | (◯) |
| . . . | | |

The user could recognize from this indication, for example, that he/she is illuminating the electronic component bearing reference symbol 1 and that said electronic component is designated as “exterior unit”.

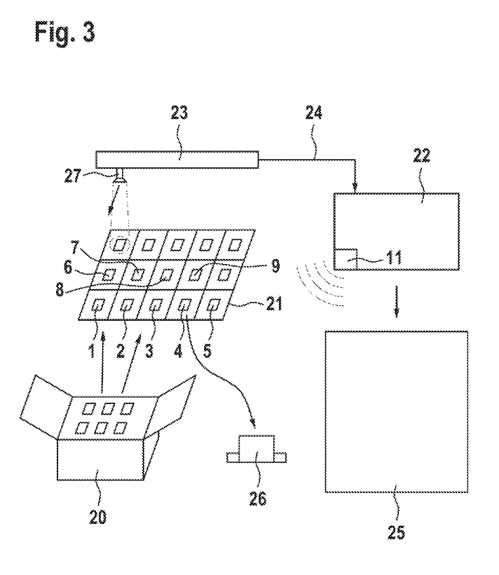

FIG. 3 shows an arrangement for preparing the electronic components 1 to 9 from FIG. 2. The electronic components 1 to 9 are provided as loose piece ware in a packaging 20. The electronic components 1 to 9 are removed therefrom and positioned on a tray 21 having suitable depressions or compartments. The depressions or compartments define preparation positions into which the electronic components 1 to 9 are positioned for preparation. The electronic components to 1 to 9 log on in a process control unit 22 via a computer network 11. An automated illumination unit 23 illuminates the electronic components 1 to 9 on the tray 21 one after another in rapid succession, but individually, and communicates the currently illuminated position as position signal 24 to the process control unit 22. From the position signal 24 and an activity signal on the light sensor channel of one of the electronic components 1 to 9, the process control unit 22 ascertains an unambiguous assignment 25 between an ID of the electronic component (uuID) and the preparation position of the electronic component (or the compartment on the tray 21). During the subsequent placement of the electronic components 1 to 9 from the tray 21 on components 26 of the installation 19, the processor control unit 22 knows which of the electronic components 1 to 9 with which ID is taken from the tray 21 and mounted on the component 26. Proceeding from the assignment 25, an unambiguous assignment of the ID of the electronic component to an ID of the component 26 (for example in the form of a serial number) can then be ascertained and stored in a database.

The placement of one of the electronic components 1 to 9 from the tray 21 on the component 26 can be carried out in an automated manner, e.g. by means of a pick-and-place robot. Alternatively, a user of the method can receive from the process control unit 22 an instruction as to from which compartment of the tray 21 an electronic component ought to be removed.

The illumination is carried out by an illumination unit 23 comprising a light source 27 having a pivotable light beam. Alternatively, it is possible to use a screen which is approximately of the size of the tray 21 and which is arranged above the tray 21. On a black background, by means of the screen, for example, white squares corresponding to the underlying compartments of the tray 21 can be displayed one after another.

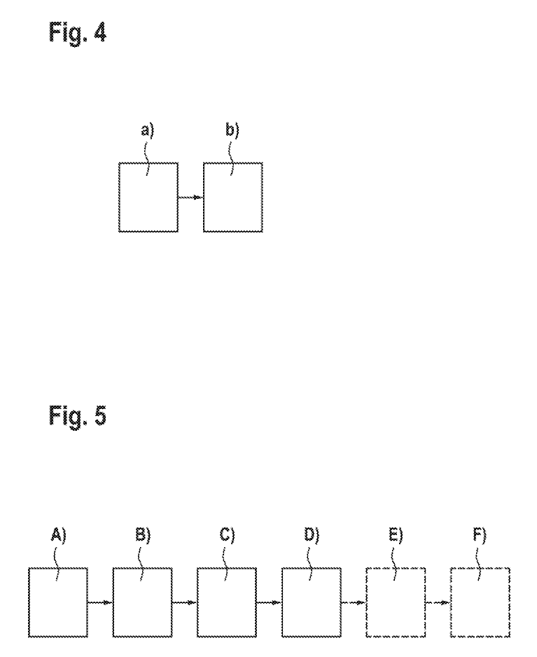

FIG. 4 shows a method for identifying an electronic component 1 to 9 from the embodiment from FIG. 1 or 2 comprising the following method steps:

a) receiving an activity signal output by the electronic component 1 to 9 if a light intensity incident on the electronic component 1 to 9 exceeds a predeterminable threshold, wherein the activity signal is assignable to the electronic component 1 to 9,
b) outputting the identification of the electronic component 1 to 9 on the basis of the activity signal received in accordance with step a).

FIG. 5 shows a method for configuring a plurality of electronic components 1 to 9 and a data network 11 for identifying the electronic components 1 to 9 in accordance with the embodiment from FIG. 3. The method comprises the following method steps which are carried out once in each case for each of the electronic components 1 to 9:

A) providing the electronic component 1 to 9 at a preparation position that is assignable to the electronic component 1 to 9,
B) illuminating the electronic component 1 to 9 provided in accordance with step A) with a light beam in the preparation position,
C) receiving an activity signal output by the electronic component 1 to 9 illuminated in accordance with step B),
D) storing an identification of the electronic component 1 to 9 in a database of the data network 11 as assigned to the preparation position of the electronic component 1 to 9.

Optionally, the method furthermore comprises the following method steps which are carried out in each case once for each of the electronic components 1 to 9:

E) positioning the electronic component 1 to 9 at a respective operation position, and
F) assigning the identification of the electronic component 1 to 9 in the database to the operation position of the electronic component 1 to 9 and/or at least one property that is assignable to the operation position.

### LIST OF REFERENCE SIGNS

1 First electronic component
2 Second electronic component
3 Third electronic component
4 Fourth electronic component
5 Fifth electronic component
6 Sixth electronic component
7 Seventh electronic component
8 Eighth electronic component
9 Ninth electronic component
10 Mobile terminal
11 Computer network
12 Light source
13 Light beam
14 Light sensor
15 Housing
16 Transparent region
17 Microcontroller
18 Display
19 Installation
20 Packaging
21 Tray
22 Process control unit
23 Illumination unit
24 Position signal
25 Assignment
26 Component
27 Light source

What is claimed is:

1. A method for identifying an electronic component, comprising:
receiving an activity signal output by the electronic component when a light intensity incident on the electronic component exceeds a predeterminable threshold;
assigning the received activity signal to the electronic component; and
outputting an identification of the electronic component based on the received activity signal.

2. The method according to claim 1, wherein outputting the identification comprises:
accessing a database in which, for a plurality of electronic components, a respective identification is stored as assigned to the corresponding electronic component; and
outputting the identification stored in the database as assigned to the electronic component from which the activity signal was received.

3. The method according to claim 1, wherein the activity signal comprises the identification of the electronic component.

4. The method according to claim 1, wherein the predeterminable threshold is time-dependent, such that the activity signal is output by the electronic component when a light signal having a predefinable light intensity sequence is received by the electronic component.

5. The method according to claim 1, further comprising:
outputting the activity signal by the electronic component only when the light intensity of at least one predefinable wavelength and/or at least one predefinable wavelength range exceeds a respective predeterminable threshold.

6. A method for configuring a plurality of electronic components and a data network for identifying the electronic components, comprising:
positioning an electronic component at a preparation position that is assignable to the electronic component;
illuminating the positioned electronic component with a light beam;
receiving an activity signal output by the illuminated electronic component; and
storing an identification of the electronic component in a database of the data network as assigned to the preparation position of the electronic component.

7. The method according to claim 6, further comprising:
positioning the electronic component at a respective operation position; and
assigning the identification of the electronic component in the database to the operation position of the electronic component and/or at least one property that is assignable to the operation position.

8. The method according to claim 6, further comprising:
illuminating the positioned electronic component with an illumination unit configured to guide a light beam onto the preparation position,
wherein a position signal with the respective illuminated preparation position is output, on the basis of which position signal the identification is assigned to the corresponding preparation position.

9. The method according to claim 6, further comprising:
illuminating the positioned electronic component with a screen including a region of the screen that is assignable to the preparation position,
wherein a position signal with the respective illuminated preparation position is output, on the basis of which position signal the identification is assigned to the corresponding preparation position.

10. The method according to claim 6, wherein the data network is configured to carry out the method.

11. The method according to claim 6, wherein a computer program is configured to carry out the method.

12. The method according to claim 11, wherein the computer program is stored on a machine-readable storage medium.

13. The method according to claim 6, wherein a process control unit is configured to carry out the method.

14. The method according to claim 6, wherein an illumination unit is configured to carry out the method.
